(19) United States
(12) Patent Application Publication
(10) Pub. No.: US 2022/0222829 A1
(43) Pub. Date: Jul. 14, 2022

(54) METHODS AND ELECTRONIC DEVICE FOR PROCESSING IMAGE

(71) Applicant: SAMSUNG ELECTRONICS CO., LTD., Suwon-si (KR)

(72) Inventors: Nitin KAMBOJ, Bengaluru (IN); Manoj Kumar MARRAMREDDY, Bengaluru (IN); Bhushan Bhagwan GAWDE, Bengaluru (IN); Pavan SUDHEENDRA, Bengaluru (IN); Jagadeesh Kumar MALLA, Bengaluru (IN); Anshul GUPTA, Bengaluru (IN); Bharath Kameswara SOMAYAJULA, Bengaluru (IN)

(73) Assignee: SAMSUNG ELECTRONICS CO., LTD., Suwon-si (KR)

(21) Appl. No.: 17/678,646

(22) Filed: Feb. 23, 2022

Related U.S. Application Data
(63) Continuation of application No. PCT/KR2022/000011, filed on Jan. 3, 2022.

(30) Foreign Application Priority Data
Jan. 12, 2021 (IN) 202141001449
Oct. 11, 2021 (IN) 2021 41001449

(51) Int. Cl. G06T 7/174; G06T 7/246; G06V 10/25

(52) U.S. Cl. CPC G06T 7/174; G06V 10/25; G06T 7/248

(57) ABSTRACT

The present disclosure relates to image processing methods and devices. In an example method for processing an image by an electronic device, the method may include acquiring a first preview frame and a second preview frame from at least one sensor. The method may further include determining at least one motion data of at least one image based on the first preview frame and the second preview frame. The method may further include identifying a first segmentation mask associated with the first preview frame. The method may further include estimating a region of interest (ROI) associated with an object present in the first preview frame based on the at least one motion data and the first segmentation mask.

### CROSS REFERENCE TO RELATED APPLICATIONS

This application is a bypass continuation of International Application No. PCT/KR2022/000011, filed on Jan. 3, 2022, which is based on and claims priority to Indian Patent Application No. 202141001449, filed on Jan. 12, 2021, in the Indian Patent Office, and Indian Patent Application No. 202141001449, filed on Oct. 11, 2021, in the Indian Patent Office, the disclosures of which are incorporated by reference herein in their entireties.

### BACKGROUND

### Field

Embodiments disclosed herein relate to image processing methods, and more particularly related to methods and electronic devices for enhancing a process of image/video segmentation using dynamic Region of Interest (ROI) segmentation.

### Description of Related Art

For camera preview/video use cases, conventionally available real-time image segmentation models may provide a segmentation map for every input frame. These segmentation maps can lack finer details, especially when distance from the camera increases or a main object occupies a smaller region of the frame, since Deep Neural Networks (DNNs) may generally operate at lower resolution due to performance constraints, for example. Further, the segmentation maps may have temporal inconsistencies at the boundaries of an image frame. These issues may be visible in video use-cases, as boundary flicker and segmentation artifacts.

For example, a portrait mode in a smartphone camera may be a popular feature. A natural extension of such a popular feature may be to extend the solution from images to videos. As such, a semantic segmentation map may need to be computed on per-frame basis to provide such a feature. The semantic segmentation map can be computationally expensive and temporally inconsistent. For a good user experience, the segmentation mask may need to be accurate and temporally consistent.

Thus, it is desired to address the above mentioned disadvantages or other shortcomings or at least provide a useful alternative.

### SUMMARY

According to an aspect of the disclosure, a method for processing an image by an electronic device includes acquiring a first preview frame and a second preview frame from at least one sensor. The method further includes determining at least one motion data of at least one image based on the first preview frame and the second preview frame. The method further includes identifying a first segmentation mask associated with the first preview frame. The method further includes estimating a ROI associated with an object present in the first preview frame based on the at least one motion data and the first segmentation mask.

According to another aspect of the disclosure, a method for processing an image by an electronic device includes acquiring a first preview frame and a second preview frame from at least one sensor. The method further includes determining at least one motion data based on the first preview frame and the second preview frame. The method further includes obtaining a first segmentation mask associated with the first preview frame and a second segmentation mask associated with the second preview frame. The method further includes converting the first segmentation mask using the at least one motion data, resulting in a converted segmentation mask. The method further includes blending the converted segmentation mask and the second segmentation mask using a dynamic per pixel weight based on the at least one motion data.

According to another aspect of the disclosure, an electronic device for processing an image, includes a processor, a memory, a segmentation controller, at least one sensor, and an image processing controller. The at least one sensor is communicatively coupled with the processor and the memory, and is configured to acquire a first preview frame and a second preview frame. The image processing controller is communicatively coupled with the processor and the memory, and is configured to determine at least one motion data of at least one image based on the first preview frame and the second preview frame. The image processing controller is further configured to identify a first segmentation mask associated with the first preview frame. The image processing controller is further configured to estimate a ROI associated with an object present in the first preview frame based on the at least one motion data and the first segmentation mask.

According to another aspect of the disclosure, an electronic device for processing an image includes a processor, a memory, a segmentation controller, at least one sensor, and an image processing controller. The least one sensor is communicatively coupled with the processor and the memory, and is configured to acquire a first preview frame and a second preview frame. The image processing controller is communicatively coupled with the processor and the memory, and is configured to determine at least one motion data based on the first preview frame and the second preview frame. The image processing controller is further configured to obtain a first segmentation mask associated with the first preview frame and a second segmentation mask associated with the second preview frame. The image processing controller is further configured to convert the first segmentation mask using the at least one motion data, resulting in a converted segmentation mask. The image processing controller is further configured to blend the converted segmentation mask and the second segmentation mask using a dynamic per pixel weight based on the at least one motion data.

These and other aspects of the embodiments herein may be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments, and the embodiments herein include all such modifications.

### BRIEF DESCRIPTION OF THE DRAWINGS

The embodiments disclosed herein are illustrated in the accompanying drawings, throughout which like reference letters indicate corresponding parts in the various figures. The embodiments herein may be better understood from the following description with reference to the drawings, in which:

FIG. 1 shows various hardware components of an electronic device for processing an image, according to embodiments as disclosed herein;

FIG. 2 is a flowchart illustrating a method for processing an image based on a region of interest (ROI), according to embodiments as disclosed herein;

FIG. 3 is another flowchart illustrating a method for processing an image using a segmentation mask, according to embodiments as disclosed herein;

FIG. 4 is an example flowchart illustrating various operations for generating a final output mask for a video, according to embodiments as disclosed herein;

FIG. 5 is an example flowchart illustrating various operations for calculating a ROI for object instances, according to embodiments as disclosed herein;

FIG. 6 is an example flowchart illustrating various operations for determining a reset condition, while estimating the ROI, according to embodiments as disclosed herein;

FIG. 7 is an example flowchart illustrating various operations for obtaining an output temporally smooth segmentation mask, according to embodiments as disclosed herein;

FIG. 8 is an example flowchart illustrating various operations for obtaining a segmentation mask to optimize the image processing, according to embodiments as disclosed herein;

FIG. 9 is an example flowchart illustrating various operations for generating a final output mask, according to embodiments as disclosed herein;

FIG. 10 is an example in which an image is provided with the ROI crop and the image is provided without the ROI crop, according to embodiments as disclosed herein; and

FIG. 11 is an example illustration in which an electronic device processes an image based on the ROI, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The terms “motion data”, “motion vector” and “motion vector information” may be used interchangeably in the patent disclosure.

The embodiments herein disclose methods and electronic devices for processing an image. The method includes acquiring, by an electronic device, a first preview frame and a second preview frame from at least one sensor. Further, the method includes determining, by the electronic device, at least one motion data of at least one image based on the acquired first preview frame and the acquired second preview frame. Further, the method includes identifying, by the electronic device, a first segmentation mask associated with the acquired first preview frame. Further, the method includes estimating, by the electronic device, a region of interest (ROI) associated with an object present in the first preview frame, based on the at least one determined motion data and the determined first segmentation mask.

For example, the method can be used to potentially minimize boundary artifacts and may reduce the flicker which may give a more accurate output and better user experience. Alternatively or additionally, the method can be used to potentially reduce temporal inconsistencies present at the boundaries of video frames and may provide better and more accurate masks, without impacting key performance indicators (KPIs), such as memory footprint, processing time and power consumption.

In some embodiments, the method can be used to potentially preserve finer details in small/distant objects by cropping the input frame which in turn may result in better quality output masks. As the finer details may be preserved without resizing, the method can be used to potentially permit running of the segmentation controller on a smaller resolution which may help in improving performance. In other embodiments, the method can be used to potentially improve the temporal consistency of the segmentation mask by combining current segmentation mask with running average of previous masks with the help of motion vector data.

In other embodiments, the method can be used for potentially enhancing the process of video segmentation using the ROI segmentation. The proposed method can be implemented in a portrait mode, a video call mode and portrait video mode, for example.

In other embodiments, the method can be used for automatically estimating the ROI which would be used to crop the input video frames sent to the segmentation controller. Alternatively or additionally, the method can be used for dynamically resetting of the ROI to full frame, in order to process substantial changes such as new objects entering in the video and/or high/sudden movements, which can be done using information from mobile sensors (gyro, accelerometer, etc.) and object information (count, size).

In other embodiments, the method can be used for deriving a per pixel weight using the motion vector information, wherein the per pixel weight may be used to combine the segmentation map of the current frame with the running average of the segmentation maps of the previous frames to enhance temporal consistency. Alternatively or additionally, the proposed method may use the motion vectors to generate the segmentation mask and the ROI using a mask of the previous frames in order to potentially achieve an enhanced output.

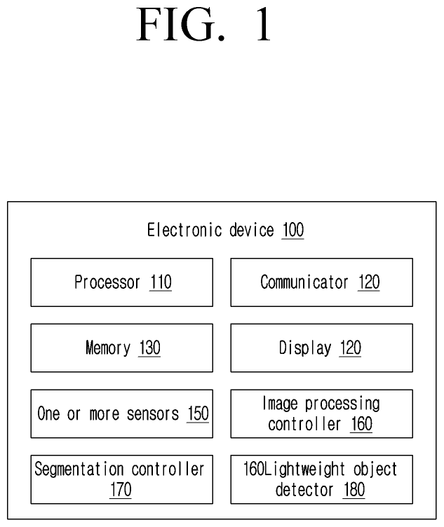

Referring now to the drawings, and more particularly to FIGS. 1 through 11, where similar reference characters denote corresponding features consistently throughout the figures, there are shown at least one embodiment.

FIG. 1 shows various hardware components of an electronic device 100 for processing an image, according to embodiments as disclosed herein. The electronic device 100 can be, for example, but is not limited to a laptop, a desktop computer, a notebook, a relay device, a vehicle to everything (V2X) device, a smartphone, a tablet, an internet of things (IoT) device, an immersive device, a virtual reality device, a foldable device, and the like. The image can be, for example, but is not limited to, a video, a multimedia content, an animated content, and the like. In an embodiment, the electronic device 100 includes a processor 110, a communicator 120, a memory 130, a display 140, one or more sensors 150, an image processing controller 160, a segmentation controller 170, and a lightweight object detector 180. The processor 110 may be communicatively coupled with the communicator 120, the memory 130, the display 140, the one or more sensors 150, the image processing controller 160, the segmentation controller 170, and the lightweight object detector 180. The one or more sensors 150 can be, for example, but not is limited to, a gyro, accelerometer, a motion sensor, a camera, a Time-of-flight (TOF) sensor, and the like.

The one or more sensors 150 may be configured to acquire a first preview frame and a second preview frame. The first preview frame and the second preview frame may be successive frames. Based on the acquired first preview frame and the acquired second preview frame, the image processing controller 160 may be configured to determine a motion data of the image. In an embodiment, the motion data may be determined using at least one of a motion estimation technique, a color based region grow technique, and a fixed amount increment technique in all directions of the image.

The color based region grow technique may be used to merge points with respect to one or more colors that may be close in terms of a smoothness constraint (e.g., the one or more colors do not deviate from each other above a predetermined threshold). In an example, the motion estimation technique may provide the per-pixel motion vectors of the first preview frame and the second preview frame. In another example, the block matching based motion vector estimation technique may be used for finding the blending map to fuse confidence maps of the first preview frame and the second preview frame to estimate the motion data of the image. Alternatively or additionally, the image processing controller 160 may be configured to identify a first segmentation mask associated with the acquired first preview frame. Based on the determined motion data and the determined first segmentation mask. the image processing controller 160 may be configured to estimate a ROI associated with an object (e.g., face, building, or the like) present in the first preview frame.

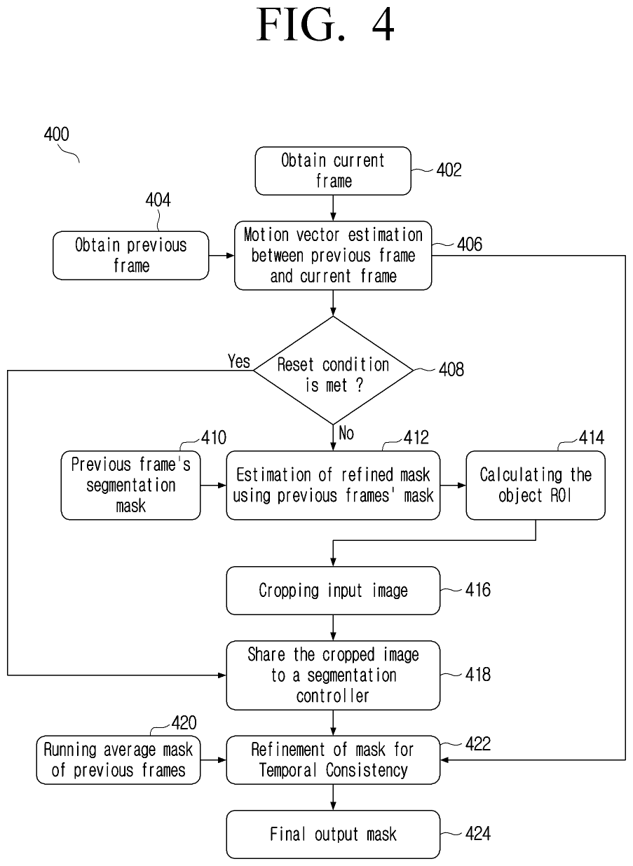

The image processing controller 160 may be configured to modify the image based on the estimated ROI. Alternatively or additionally, the image processing controller 160 may be configured to serve the modified image in the segmentation controller 170 to obtain the second segmentation mask. An example flowchart illustrating various operations for generating the final output mask for a video is described in reference to FIG. 4.

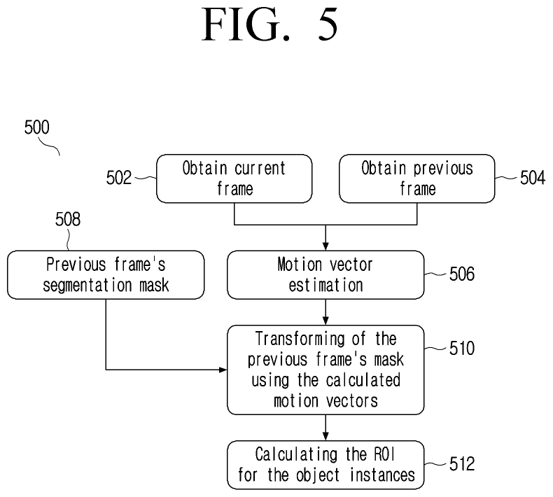

In some embodiments, the image processing controller 160 may be configured to obtain the motion data, a sensor data and an object data. Based on the motion data, the sensor data and the object data, the image processing controller 160 may be configured to identify that a frequent change in the motion data or a frequent change in a scene. The frequent change in the motion data and the frequent change in the scene may be determined using the fixed interval technique and a lightweight object detector 180. Based on the identification, the image processing controller 160 may be configured to dynamically reset the ROI associated with the object present in the first preview frame for re-estimating the ROI associated with the object. In an example, the sensor information along with a scene information, such as face data (from the camera), may be available and can be used to detect high motion or changes in the scene to reset ROI to full the input frame. An example flowchart illustrating various operations for calculating the ROI for object instances is described in reference to FIG. 5.

In some embodiments, the image processing controller 160 may be configured to convert the first segmentation mask using the determined motion data. Based on the motion data, the image processing controller 160 may be configured to blend the converted segmentation mask and the second segmentation mask using the dynamic per pixel weight.

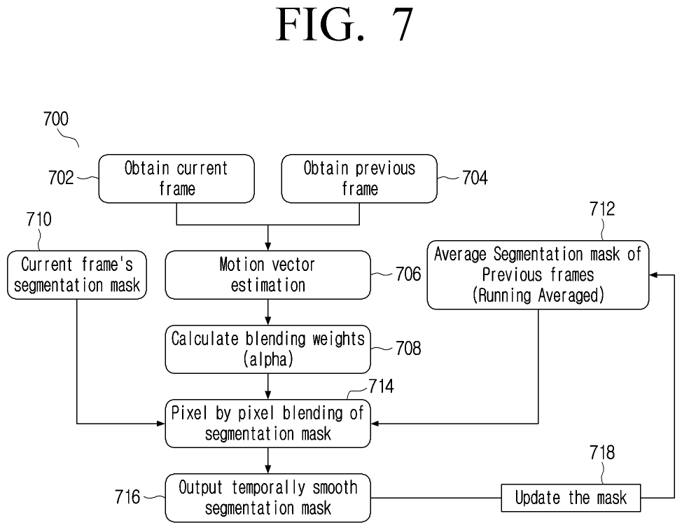

In some embodiments, the image processing controller 160 may be configured to obtain a segmentation mask output and to optimize the image processing based on the segmentation mask output. An example flowchart illustrating various operations for obtaining the output temporally smooth segmentation mask is described in reference to FIG. 7. In an embodiment, the dynamic per pixel weight may be determined by estimating a displacement value to be equal to a Euclidian distance between a center (e.g., a geometrical center) of the first preview frame and a center (e.g., a geometrical center) of the second preview frame, and determining the dynamic per pixel weight based on the estimated displacement value. In an example, the dynamic per pixel weight may be determined as described below.

For example, the input image may be divided into N×N blocks (e.g., common values for N may include positive integers that are powers of 2, such as 4, 8, and 16). For each N×N block centered at (X₀, Y₀) in the previous input frame, a N×N block in the current frame centered at (X₁, Y₁) may be found by minimizing a sum of absolute differences between the blocks in a neighborhood of maximum size S.

The values, (X₀, Y₀):(X₁, Y₁), for each N×N block, may be used to transform the previous segmentation mask which may then be used to estimate an ROI for cropping the current input frame before passing to the segmentation controller 170.
a) Metadata information from the motion sensors combined with the camera frame analysis data can be used to reset the ROI to full frame.
b) For each block, a displacement value D may be computed to be equal to the Euclidian distance between (X₀, Y₀) & (X₁, Y₁) according to Eq. 1.

D=(X₀−X₁)²+(Y₀−Y₁)² (Eq. 1)
c) The displacement value D may then be used to compute alpha blending weight a for merging the previous segmentation mask with the current mask according to Eq. 2.

a=(MAXₐ−MINₐ)*(1.0−D/2*S)+MINₐ (Eq. 2)
where S represents a maximum search range for block matching, and MAXₐ, MINₐ may be determined according to segmentation controller used.

In another example, any numerical technique that can convert a range of values to a binary range (e.g., 0-1) can be used for computing a per pixel weight. In another example, a Gaussian distribution with a mean equal to 0 and a sigma equal to a maximum Euclidean distance may be used to convert Euclidean distances to per-pixel weights. Alternatively or additionally, a Manhattan distance (e.g., L1, L2) may be used instead of the Euclidean distance.

In another embodiment, the image processing controller 160 may be configured to determine the motion data based on the acquired first preview frame and the acquired second preview frame. Alternatively or additionally, the image processing controller 160 may be configured to obtain the first segmentation mask associated with the acquired first preview frame and the second segmentation mask associated with the acquired second preview frame. In other embodiments, the image processing controller 160 may be configured to convert the first segmentation mask using the determined motion data. Alternatively or additionally, the image processing controller 160 may be configured to blend the converted segmentation mask and the second segmentation mask using the dynamic per pixel weight based on the motion data.

In some embodiments, the image processing controller 160 may be configured to obtain the segmentation mask output based on the blending and optimize the image processing based on the segmentation mask output.

Based on the proposed method, the output mask from the segmentation controller 170 can have various temporal inconsistencies even around static boundary regions. The output mask from a previous frame may be combined with the current mask to potentially improve the temporal consistency.

The image processing controller 160 may be implemented by analog and/or digital circuits such as logic gates, integrated circuits, microprocessors, microcontrollers, memory circuits, passive electronic components, active electronic components, optical components, hardwired circuits, or the like, and may optionally be driven by firmware.

The segmentation controller 170 may be implemented by analog and/or digital circuits such as logic gates, integrated circuits, microprocessors, microcontrollers, memory circuits, passive electronic components, active electronic components, optical components, hardwired circuits, or the like, and may optionally be driven by firmware.

In some embodiments, the processor 110 may be configured to execute instructions stored in the memory 130 and to perform various processes. The communicator 120 may be configured for communicating internally between internal hardware components and/or with external devices via one or more networks. The memory 130 may store instructions to be executed by the processor 110. The memory 130 may include non-volatile storage elements. Examples of such non-volatile storage elements may include, but are not limited to, magnetic hard discs, optical discs, floppy discs, flash memories, or forms of electrically programmable memories (EPROM), and electrically erasable and programmable (EEPROM) memories. In addition, the memory 130 may, in some examples, be considered a non-transitory storage medium. The term “non-transitory” may indicate that the storage medium is not embodied in a carrier wave or a propagated signal. However, the term “non-transitory” should not be interpreted that the memory 130 is non-movable. In certain examples, a non-transitory storage medium may store data that can, over time, change (e.g., in Random Access Memory (RAM) or cache).

Further, at least one of the plurality of modules/controller may be implemented through an artificial intelligence (AI) model. A function associated with the AI model may be performed through the non-volatile memory, the volatile memory, and the processor 110. The processor 110 may include one or a plurality of processors. The one processor or each processor of the plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one processor or each processor of the plurality of processors may control the processing of the input data in accordance with a predefined operating rule and/or an AI model stored in the non-volatile memory and/or the volatile memory. The predefined operating rule and/or the artificial intelligence model may be provided through training and/or learning.

Here, being provided through learning may refer to a predefined operating rule and/or an AI model of a desired characteristic that may be made by applying a learning algorithm to a plurality of learning data. The learning may be performed in a device itself in which AI according to an embodiment may be performed, and/or may be implemented through a separate server/system.

The AI model may comprise a plurality of neural network layers. Each layer may have a plurality of weight values, and may perform a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm may be a method for training a predetermined target device (e.g., a robot) using a plurality of learning data to cause, allow, or control the target device to make a determination and/or a prediction. Examples of learning algorithms include, but are not limited to, supervised learning, unsupervised learning, semi-supervised learning, or reinforcement learning.

Although FIG. 1 shows various hardware components of the electronic device 100, it is to be understood that other embodiments are not limited thereon. In other embodiments, the electronic device may include less or more components. Furthermore, the labels or names of the components are used only for illustrative purposes and do not limit the scope of the invention. One or more components can be combined together to perform same or substantially similar functionality in the electronic device 100.

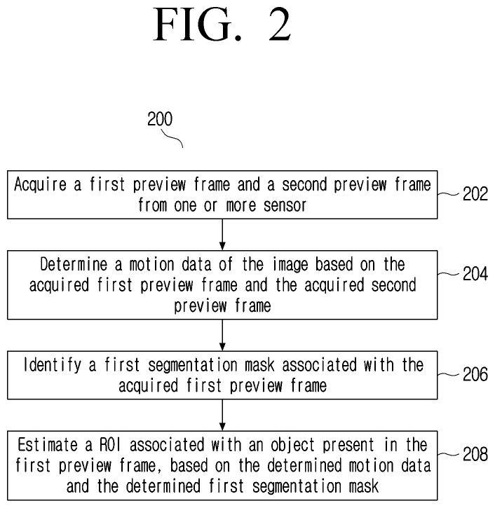

FIG. 2 is a flowchart illustrating a method 200 for processing the image based on the ROI, according to embodiments as disclosed herein. The operations of method 200 (e.g., blocks 202-208) may be performed by the image processing controller 160.

At block 202, the method 200 includes acquiring the first preview frame and the second preview frame from the one or more sensors 150. At block 204, the method 200 includes determining the motion data of the image based on the acquired first preview frame and the acquired second preview frame. At block 206, the method 200 includes identifying the first segmentation mask associated with the acquired first preview frame. At block 208, the method 200 includes estimating the ROI associated with the object present in the first preview frame based on the determined motion data and the determined first segmentation mask.

For example, the method can be used to potentially minimize the boundary artifacts and may reduce the flicker which may give a more accurate output and better user experience. Alternatively or additionally, the method can be used to potentially reduce temporal inconsistencies present at the boundaries of video frames and may provide better and accurate masks, without impacting KPIs (e.g., memory footprint, processing time, and power consumption).

In some embodiments, the method can be used to potentially preserve the finer details in small/distant objects by cropping the input frame which in turn may result in better quality output masks. As the finer details may be preserved without resizing, the method 200 can be used to permit running of the segmentation controller 170 on a smaller resolution which helps in improving performance. The method 200 can be used to potentially improve the temporal consistency of the segmentation mask by combining current segmentation mask with running average of previous masks with the help of motion vector data. The method 200 can be used to potentially improve the segmentation quality using the adaptive ROI estimation and potentially improve the temporal consistency in the segmentation mask.

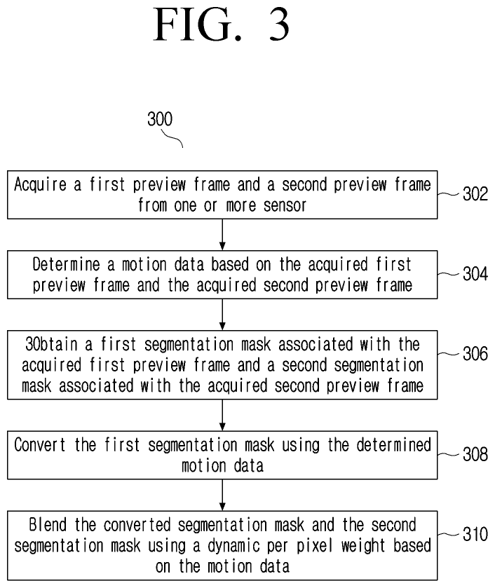

FIG. 3 is another flowchart illustrating a method 300 for processing the image using the segmentation mask, according to embodiments as disclosed herein. The operations of method 300 (e.g., blocks 302-310) may be performed by the image processing controller 160.

At block 302, the method 300 includes acquiring the first preview frame and the second preview frame from the one or more sensors 150. At block 304, the method 300 includes determining the motion data based on the acquired first preview frame and the acquired second preview frame. At block 306, the method 300 includes obtaining the first segmentation mask associated with the acquired first preview frame and the second segmentation mask associated with the acquired second preview frame. At block 308, the method 300 includes converting the first segmentation mask using the determined motion data. At block 310, the method 300 includes blending the converted segmentation mask and the second segmentation mask using the dynamic per pixel weight based on the motion data.

FIG. 4 is an example flowchart illustrating various operations of a method 400 for generating the final output mask for a video, according to embodiments as disclosed herein. The operations of method 400 (e.g., blocks 402-424) may be performed by the image processing controller 160.

At block 402, the method 400 includes obtaining the current frame. At block 404, the method 400 includes obtaining the previous frame. At block 406, the method 400 includes estimating the motion vector between the previous frame and current frame. At block 408, the method 400 includes determining whether the reset condition has been met. If or when the reset condition has been met then, at block 410, the method 400 includes obtaining the segmentation mask of the previous frame and at block 412, the method 400 includes estimating a refined mask the using segmentation mask of the previous frames. At block 414, the method 400 includes computing the object ROI. At block 416, the method 400 includes cropping the input image based on the computation. At block 418, the method 400 includes sharing the cropped image to the segmentation controller 170. At block 420, the method 400 includes executing the average mask of the previous frames. At block 422, the method 400 includes obtaining the refinement of mask for the temporal consistency. At block 424, the method 400 includes obtaining the final output mask.

FIG. 5 is an example flowchart illustrating various operations of a method 500 for calculating the ROI for the object instances, according to embodiments as disclosed herein. Conventionally, the ROI may be constructed around the subject in the mask of the previous frame and increased up to some extent to take into account the displacement of subject. The method 500 can be used to adaptively construct the ROI by considering the displacement and the direction of motion of the subject from previous frame to the current frame. As such, the method 500 may provide an improved (e.g., tighter) bounding box for objects of interest in the current frame. For the direction of motion, the method 500 can be used to calculate the motion vectors between the previous and current input frame. The motion vectors may be calculated using block matching based techniques, such as, but is not limited to, a diamond search algorithm, a three step search algorithm, a four step search algorithm, and the like. Using these estimated vectors, the method 500 can be used to transform the mask of the previous frames to create a new mask. Based on the new mask, the method 500 can be used to crop the current input image and this cropped image may be sent to the segmentation controller 170 instead of the entire input image. Since the cropped image has been sent to a neural network, a potentially higher quality output segmentation mask can be obtained, for example, for distant/small objects and near the boundaries.

As shown in FIG. 5, the operations of method 500 (e.g., blocks 502-512) may be performed by the image processing controller 160. At block 502, the method 500 includes obtaining the current frame. At block 504, the method 500 includes obtaining the previous frame. At block 506, the method 500 includes estimating the motion vector. At block 508, the method 500 includes obtaining the segmentation mask of the previous frame. At block 510, the method 500 includes transforming the mask of the previous frame using the calculated motion vectors. At block 512, the method 500 includes calculating the ROI for the object instances.

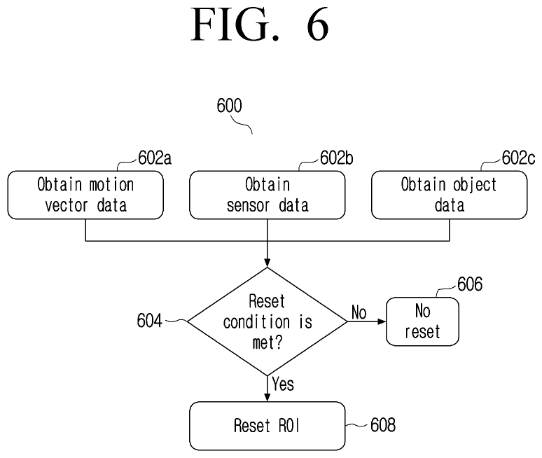

FIG. 6 is an example flowchart illustrating various operations of a method 600 for determining the reset condition, while estimating the ROI, according to embodiments as disclosed herein.

Conventionally, the ROI estimation may be reset at frequent intervals. Alternatively or additionally to resetting the frame at regular intervals, the method 600 may use the information from the mobile sensors (e.g., gyro, accelerometer etc.), object information (e.g., count, location and size) and motion data (e.g., calculated using motion estimation) to dynamically reset the ROI to full frame in order to process substantial changes such as new objects entering in video and/or high/sudden movements. Alternatively or additionally, the dynamic resetting of the calculated ROI to full frame may use scene metadata (e.g. number of faces) and/or sensor data from a camera device to incorporate sudden scene changes.

As shown in FIG. 6, the operations of method 600 (e.g., blocks 602a-608) may be performed by the image processing controller 160. At block 602a, the method 600 includes obtaining the motion vector data. At block 602b, the method 600 includes obtaining the sensor data. At block 602c, the method 600 includes obtaining the object data. At block 602, the method 600 includes determining whether the reset condition has been met. If or when the reset condition has been met then, at block 608, the method 600 includes resetting the ROI. If or when the reset condition has not been met then, at block 606, the method 600 does not reset the ROI.

FIG. 7 is an example flowchart illustrating various operations of a method 700 for obtaining the output temporally smooth segmentation mask, according to embodiments as disclosed herein. The operations of method 700 (e.g., blocks 702-718) may be performed by the image processing controller 160.

At block 702, the method 700 includes obtaining the current frame. At block 704, the method 700 includes obtaining the previous frame. At block 706, the method 700 includes estimating the motion vector. At block 708, the method 700 includes calculating the blending weights (e.g., alpha weights). At block 710, the method 700 includes obtaining the segmentation mask of the current frame. At block 712, the method 700 includes obtaining the average segmentation mask of the previous frames (running averaged). At block 714, the method 700 includes performing the pixel by pixel blending of segmentation mask. At block 716, the method 700 includes obtaining the output temporally smooth segmentation mask. At block 718, the method 700 includes updating the mask in the electronic device 100.

In another embodiment, the motion vectors may be estimated between the previous and current input frame. For example, the motion vectors may be estimated using block matching based techniques, such as, but not limited to, a diamond search algorithm, a three step search algorithm, a four step search algorithm, and the like. These motion vectors may be mapped to the alpha map which may be used for blending the segmentation masks. This alpha map may have values from 0-255 which may be further normalized to fall within the binary range (e.g., 0-1). Depending on the alpha map value, embodiments herein blend the segmentation mask of the current frame and average segmentation mask of previous frames. For example, if high motion has been predicted for a particular block, then more weight may be assigned to the corresponding block in current segmentation mask and less weight may be given to the corresponding block in averaged segmentation mask of previous frames while blending the masks. In an example, the method 700 may perform the blending of masks using Eq. 3.

New_Mask=Previous_avg_mask*alpha+Current_mask*(1−alpha) (Eq. 3)

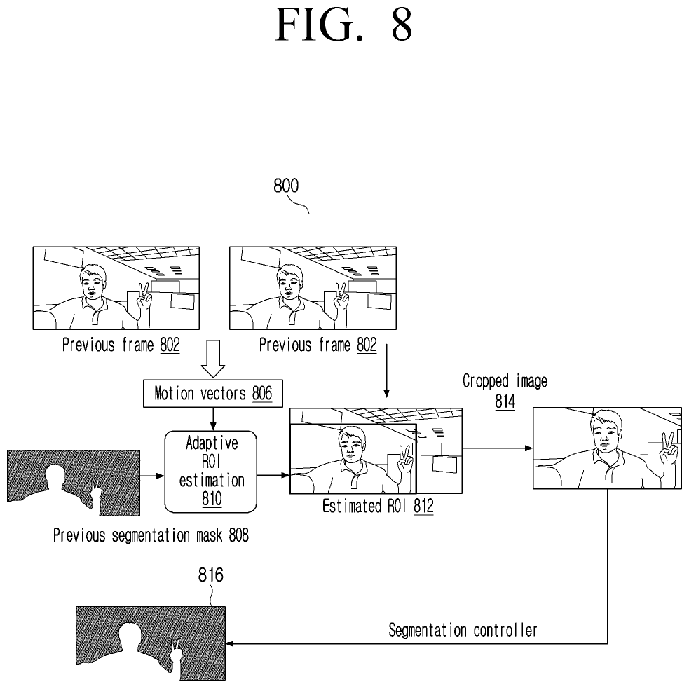

FIG. 8 is an example flowchart illustrating various operations of a method 800 for obtaining the second segmentation mask to optimize the image processing, according to embodiments as disclosed herein. The operations of method 800 (e.g., blocks 802-816) may be performed by the image processing controller 160. At block 802, the method 800 includes obtaining the current frame. At block 804, the method 800 includes obtaining the previous frame. At block 806, the method 800 includes estimating the motion vector. At block 808, the method 800 includes obtaining the previous segmentation mask. At block 810, the method 800 includes estimating the ROI associated with the object present in the first preview frame based on the determined motion data and the determined first segmentation mask at block 812. At block 814, the method 800 includes cropping the image based on the estimated ROI. At block 816, the method 800 includes serving the cropped image in the segmentation controller 170 to obtain the second segmentation mask to optimize the image processing.

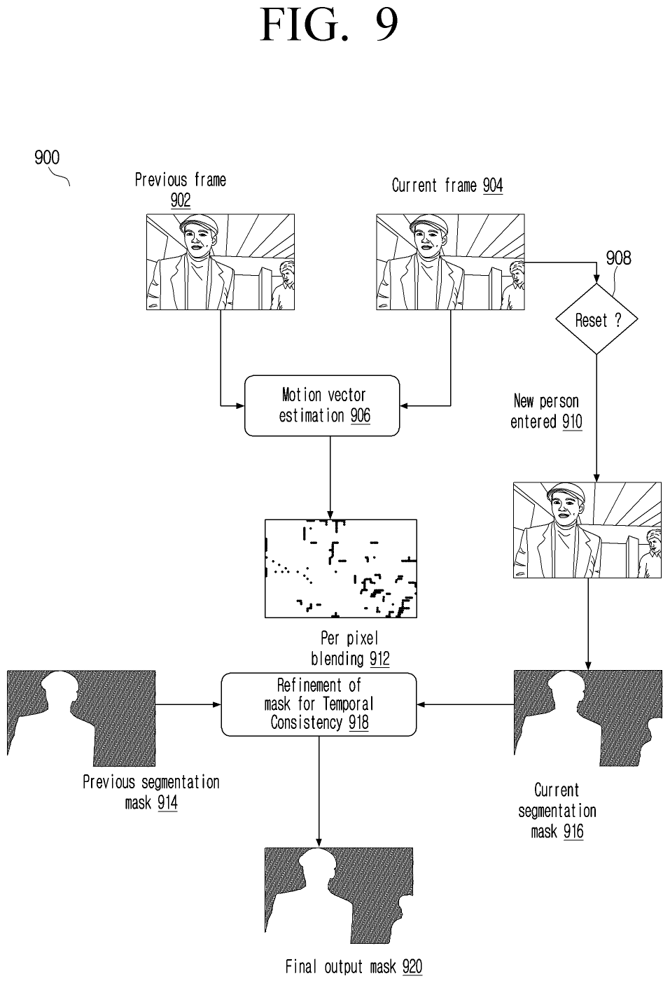

FIG. 9 is an example flowchart illustrating various operations of method 900 for generating the final output mask, according to embodiments as disclosed herein. The operations of method 900 (e.g., blocks 902-920) may be performed by the image processing controller 160.

At block 902, the method 900 includes obtaining the previous frame. At block 904, the method 900 includes obtaining the current frame. At block 906, the method 900 includes estimating the motion vector between the previous frame and current frame. At blocks 908 and 910, the method 900 includes determining whether the reset condition has been met by new person entering in the frame. At block 912, the method 900 includes performing the pixel by pixel blending of segmentation mask. At block 914, the method 900 includes obtaining the previous segmentation mask. At block 916, the method 900 includes obtaining the current segmentation mask. At block 918, the method 900 includes obtaining the refinement of the mask for the temporal consistency based on the previous segmentation mask, the current segmentation mask and the pixel by pixel blending of segmentation mask. At block 920, the method 900 includes obtaining the final output mask based on the obtained refinement.

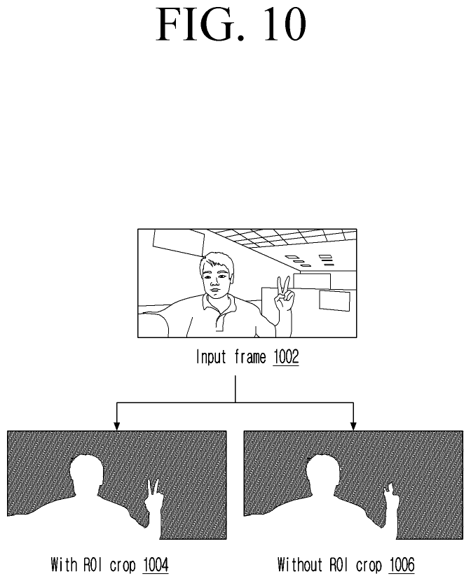

FIG. 10 is an example in which the image 1002 has been provided with the ROI crop 1004 and the image has been provided without the ROI crop 1004, according to embodiments as disclosed herein. The electronic device 100 can be adopted on top of any conventional segmentation techniques to potentially improve the segmentation quality and may provide an efficient manner to introduce temporal consistency in the resulting images.

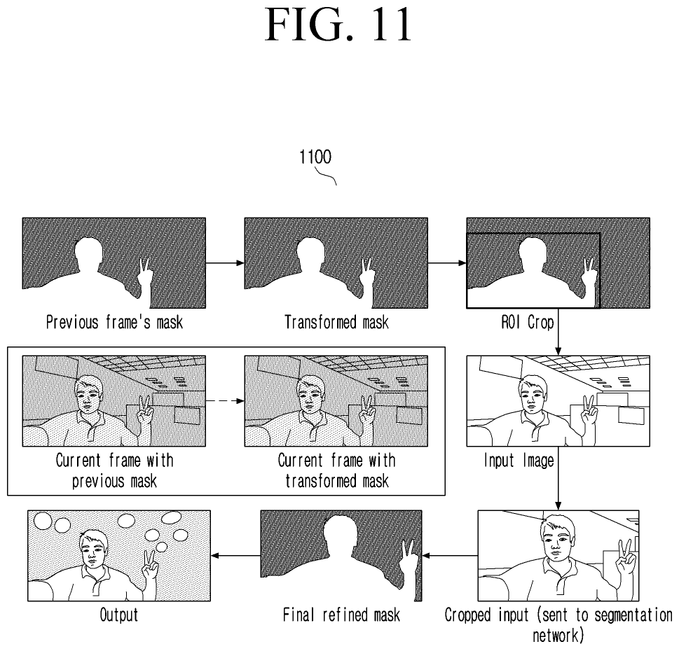

FIG. 11 is an example illustration 1100 in which the electronic device 100 processes the image based on the ROI, according to embodiments as disclosed herein. The operations and functions of the electronic device 100 have been described in reference to FIGS. 1-10.

The various actions, acts, blocks, steps, or the like in the flowcharts (e.g., flowcharts 300-900) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments may fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art may recognize that the embodiments herein can be practiced with modification within the scope of the embodiments as described herein.

What is claimed is:

1. A method for processing an image by an electronic device, comprising:
acquiring a first preview frame and a second preview frame from at least one sensor;
determining at least one motion data of at least one image based on the first preview frame and the second preview frame;
identifying a first segmentation mask associated with the first preview frame; and
estimating a region of interest (ROI) associated with an object present in the first preview frame based on the at least one motion data and the first segmentation mask.

2. The method according to claim 1, further comprising:
modifying the at least one image based on the ROI, resulting in at least one modified image; and
serving the at least one modified image to a segmentation controller to obtain a second segmentation mask.

3. The method according to claim 1, further comprising:
obtaining the at least one motion data, a sensor data and an object data;
identifying, based on the at least one motion data, the sensor data and the object data, at least one of a first frequent change in the at least one motion data and a second frequent change in a scene, wherein the at least one of the first frequent change in the at least one motion data and the second frequent change in the scene are determined using at least one of a fixed interval technique and a lightweight object detector; and
dynamically resetting the ROI associated with the object present in the first preview frame for re-estimating the ROI associated with the object.

4. The method according to claim 2, further comprising:
converting the first segmentation mask using the at least one motion data, resulting in a converted segmentation mask;
blending the converted segmentation mask and the second segmentation mask using a dynamic per pixel weight based on the at least one motion data;
obtaining a segmentation mask output; and
optimizing the image processing based on the segmentation mask output.

5. The method according to claim 4, wherein the dynamic per pixel weight is determined by:
estimating a displacement value to be equal to a Euclidian distance between a first center of the first preview frame and a second center of the second preview frame; and
determining the dynamic per pixel weight based on the displacement value.

6. The method according to claim 1, wherein the at least one motion data is determined using at least one of a motion estimation technique, a color based region grow technique, and a fixed amount increment technique in all directions of the at least one image.

7. The method according to claim 1, wherein the first preview frame and the second preview frame are successive frames.

8. A method for processing an image by an electronic device, comprising:
acquiring a first preview frame and a second preview frame from at least one sensor;
determining at least one motion data based on the first preview frame and the second preview frame;
obtaining a first segmentation mask associated with the first preview frame and a second segmentation mask associated with the second preview frame;
converting the first segmentation mask using the at least one motion data, resulting in a converted segmentation mask; and
blending the converted segmentation mask and the second segmentation mask using a dynamic per pixel weight based on the at least one motion data.

9. The method according to claim 8, further comprising:
obtaining a segmentation mask output based on the blending; and
optimizing the image processing based on the segmentation mask output.

10. The method according to claim 8, wherein the dynamic per pixel weight is determined by:
estimating a displacement value to be equal to a Euclidian distance between a first center of the first preview frame and a second center of the second preview frame, wherein the first preview frame and the second preview frame are successive frames; and
determining the dynamic per pixel weight based on the displacement value.

11. An electronic device for processing an image, comprising:
a processor;
a memory;
a segmentation controller;
at least one sensor, communicatively coupled with the processor and the memory, configured to acquire a first preview frame and a second preview frame; and
an image processing controller, communicatively coupled with the processor and the memory, configured to:
determine at least one motion data of at least one image based on the first preview frame and the second preview frame,
identify a first segmentation mask associated with the first preview frame, and
estimate a region of interest (ROI) associated with an object present in the first preview frame based on the at least one motion data and the first segmentation mask.

12. The electronic device according to claim 11, wherein the image processing controller is further configured to:
modify the at least one image based on the ROI, resulting in at least one modified image; and
serve the at least one modified image in the segmentation controller to obtain a second segmentation mask.

13. The electronic device according to claim 11, wherein the image processing controller is further configured to:
obtain the at least one motion data, a sensor data and an object data;
identify, based on the at least one motion data, the sensor data and the object data, at least one of a first frequent change in the at least one motion data and a second frequent change in a scene, wherein the at least one of the first frequent change in the at least one motion data and the second frequent change in the scene are determined using at least one of a fixed interval technique and a lightweight object detector; and
dynamically reset the ROI associated with the object present in the first preview frame for re-estimating the ROI associated with the object.

14. The electronic device according to claim 12, wherein the image processing controller is further configured to:
convert the first segmentation mask using the at least one motion data, resulting in a converted segmentation mask;
blend the converted segmentation mask and the second segmentation mask using a dynamic per pixel weight based on the at least one motion data;
obtain a segmentation mask output; and
optimize the image processing based on the segmentation mask output.

15. The electronic device according to claim 14, wherein the dynamic per pixel weight is determined by:
estimating a displacement value to be equal to a Euclidian distance between a first center of the first preview frame and a second center of the second preview frame; and
determining the dynamic per pixel weight based on the displacement value.

16. The electronic device according to claim 11, wherein the at least one motion data is determined using at least one of a motion estimation technique, a color based region grow technique, and a fixed amount increment technique in all directions of the at least one image.

17. The electronic device according to claim 11, wherein the first preview frame and the second preview frame are successive frames.

18. An electronic device for processing an image, comprising:
a processor;
a memory;
a segmentation controller;
at least one sensor, communicatively coupled with the processor and the memory, configured to acquire a first preview frame and a second preview frame; and
an image processing controller, communicatively coupled with the processor and the memory, configured to:
determine at least one motion data based on the first preview frame and the second preview frame,
obtain a first segmentation mask associated with the first preview frame and a second segmentation mask associated with the second preview frame,
convert the first segmentation mask using the at least one motion data, resulting in a converted segmentation mask, and
blend the converted segmentation mask and the second segmentation mask using a dynamic per pixel weight based on the at least one motion data.

19. The electronic device according to claim 18, wherein the image processing controller is further configured to:
obtain a segmentation mask output based on the blending; and
optimize the image processing based on the segmentation mask output.

20. The electronic device according to claim 18, wherein the dynamic per pixel weight is determined by:
estimating a displacement value to be equal to a Euclidian distance between a first center of the first preview frame and a second center of the second preview frame, wherein the first preview frame and the second preview frame are successive frames; and
determining the dynamic per pixel weight based on the displacement value.
